(19) United States
(12) Patent Application Publication
(10) Pub. No.: US 2013/0076497 A1
(43) Pub. Date: Mar. 28, 2013

(54) VEHICLE ARRANGEMENT RESPONSIVE TO AMOUNT OF MATERIAL IN A TOWED VEHICLE

(71) Applicants: Alan D. Sheidler, Moline, IL (US); Noel W. Anderson, Fargo, ND (US)

(72) Inventors: Alan D. Sheidler, Moline, IL (US); Noel W. Anderson, Fargo, ND (US)

(21) Appl. No.: 13/241,993

(22) Filed: Sep. 23, 2011

(51) Int. Cl. G08B 21/00

(52) U.S. Cl. 340/431

(57) ABSTRACT

A vehicle arrangement includes a tow vehicle and a towed vehicle. The towed vehicle includes at least two wheels and at least one motor, with each motor being coupled with a corresponding wheel. An indicator associated with an amount of material carried onboard the towed vehicle provides an output signal representing the amount of material. An electrical processing circuit is coupled with the indicator and actuates at least one motor, dependent upon the output signal.

### FIELD OF THE INVENTION

The present invention relates to arrangements for towing a towed vehicle behind a tow vehicle, and, more particularly, to arrangements for towing a towed implement behind a work vehicle.

### BACKGROUND OF THE INVENTION

When using agricultural equipment, it is common to pull a towed vehicle behind a tow vehicle. For example, during a harvesting operation, it is common to pull a grain cart or gravity box behind a tractor. When the grain bin in the combine is full, the grain cart or gravity box is pulled along side of the combine, the unloading auger is swung to the side of the combine, and the grain is offloaded into the cart or gravity box. The full cart or gravity box may then be transported to a dryer location, such as an on-farm batch or bin dryer, or a local elevator.

As another example, it is also common to pull a fertilizer spreader behind a tractor for application of fertilizer, lime, etc. to an agricultural field.

When pulling a towed vehicle such as an agricultural cart, wagon, spreader or the like behind a tractor, the weight of the towed vehicle when full with product can be substantial. For this reason, it is common to use a relatively large tractor to pull such a towed vehicle. The weight effects of a towed vehicle on a tow vehicle are further compounded when a number of towed vehicles are connected together in a train arrangement, such as a number of loaded gravity boxes which are trained together and pulled to a dryer location using a single tractor.

What is needed in the art is a way of towing a heavy towed vehicle or train of towed vehicles, without adversely affecting the operation of the tow vehicle.

### SUMMARY

The present invention provides a towed vehicle arrangement in which one or more wheels on the towed vehicle are driven and/or braked in response to an amount of material in the towed vehicle.

The invention in one form is directed to a vehicle arrangement including a tow vehicle and a towed vehicle. The towed vehicle includes at least two wheels and at least one motor, with each motor being coupled with a corresponding wheel. An indicator associated with an amount of material carried onboard the towed vehicle provides an output signal representing the amount of material. An electrical processing circuit is coupled with the indicator and actuates at least one motor, dependent upon the output signal.

The invention in another form is directed to a method of towing a towed vehicle using a tow vehicle. The towed vehicle has at least one motor with each motor being coupled with a corresponding wheel. The method includes the steps of: determining an amount of material carried onboard the towed vehicle; and actuating at least one motor using an electrical processing circuit, dependent upon the determined amount of material.

### BRIEF DESCRIPTION OF THE DRAWINGS

The above-mentioned and other features and advantages of this invention, and the manner of attaining them, will become more apparent and the invention will be better understood by reference to the following description of embodiment of the invention taken in conjunction with the accompanying drawings, wherein:

FIG. 1 is a perspective view of an embodiment of a towed vehicle of the present invention in the form of a fertilizer spreader;

FIG. 2 is a schematic view of the fertilizer spreader shown in FIG. 1; and

FIG. 3 is a flowchart illustrating an embodiment of a method of the present invention for towing a towed vehicle.

Corresponding reference characters indicate corresponding parts throughout the several views. The exemplification set out herein illustrates an embodiment of the invention, in one form, and such exemplification is not to be construed as limiting the scope of the invention in any manner.

### DETAILED DESCRIPTION

Referring now to the drawings, and more particularly to FIG. 1, there is shown an embodiment of a vehicle arrangement of the present invention including a towed vehicle 10 which is towed by a tow vehicle 12. Towed vehicle 10 is shown in the form of a fertilizer spreader in the illustrated embodiment, but could be any type of other towed vehicle. For example, towed vehicle 10 could also be in the form of a grain cart, a gravity box, an air cart, etc.

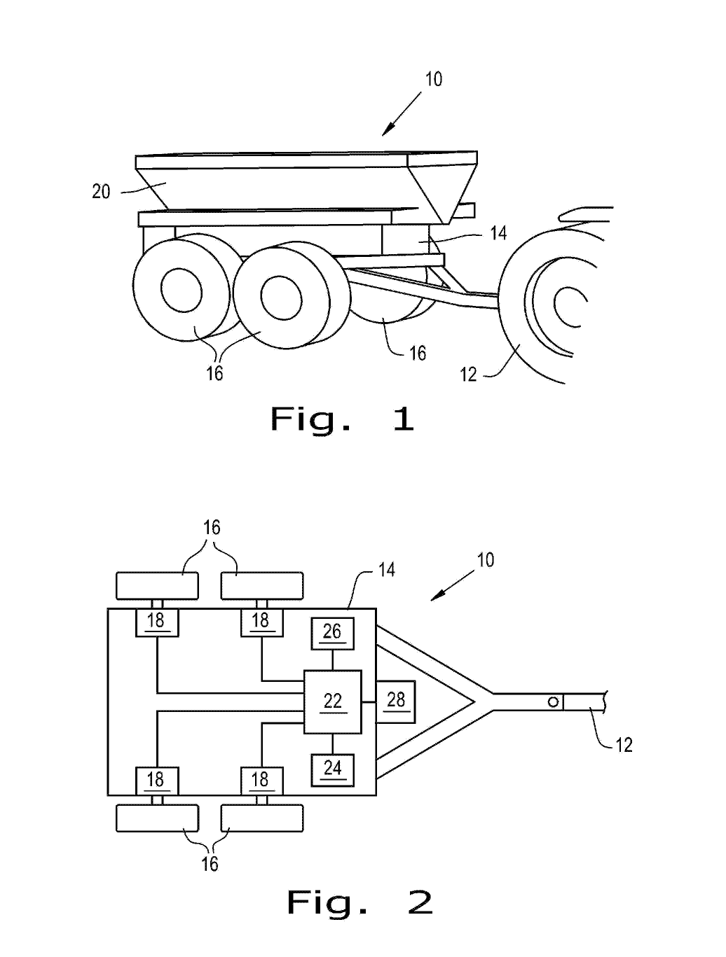

Towed vehicle 10 (FIGS. 1 and 2) generally includes a frame 14, at least two wheels 16 carried by frame 14, at least one motor 18, a hopper 20, and an electrical processing circuit 22.

In the illustrated embodiment, towed vehicle 10 includes four wheels 16, but may include a different number of wheels, depending on the application.

Towed vehicle 10 is shown as including four motors 18 which are respectively coupled with a corresponding wheel 16. However, towed vehicle 10 need not necessarily include a motor 18 associated with each corresponding wheel 16. For example, towed vehicle 10 could be provided with a pair of motors 18 with a single motor on each side. Motors 18 are assumed to be electric motors in the illustrated embodiment, but could be differently configured depending on the application, such as hydraulic motors.

When configured as electric motors, it is desirable to provide towed vehicle 10 with an onboard source of electrical power, such as a single battery 24, one or more fuel cells, or a bank of batteries. The electrical power could also be obtained from an onboard internal combustion engine (i.e., the alternator/generator output of such an engine). Alternatively, it is also possible to obtain electrical power from a similar electrical source onboard tow vehicle 12.

According to an aspect of the present invention, an indicator 26 associated with an amount of material in hopper 20 onboard towed vehicle 10 provides an output signal representing the amount of material (e.g., corn, fertilizer, lime, etc.). It will be appreciated that the amount of material in hopper 20 typically varies at any given point in time during use. For example, when configured as a fertilizer spreader as shown, the amount of fertilizer within hopper 20 decreases as the fertilizer is spread on the field. As another example, when configured as a grain cart, the amount of grain within hopper 20 increases as the combine offloads successive loads into the grain cart. Thus, indicator 26 is preferably configured to indicate an amount of material carried onboard towed vehicle 10 at any given point in time during operation of towed vehicle 10.

Indicator 26 can be configured to a) sense an amount of material carried by towed vehicle 10, or b) infer an amount of material carried by towed vehicle 10. For example, indicator 26 may be configured as a) an onboard scale; b) an onboard optical sensor; c) an on-board ultrasonic sensor, d) at least one contact switch; and e) a remote indicator. When configured as a remote indicator, indicator 26 may be, e.g., a) an external scale; b) a mass flow sensor; and/or c) a grain yield monitor.

One example of a remote indicator is a mass flow sensor mounted on a combine auger. As grain is transferred from the combine to a grain cart, the mass of grain transferred is measured. This mass value is then transferred using wireless communications, such as wi-fi to the electrical processing unit on the grain cart or the tractor towing it. The mass of grain transferred may be added to the mass of the grain cart when empty to determine a mass used for control purposes.

Electrical processing circuit 22 receives an output signal from indicator 26 and actuates one or more motors 18, dependent upon the output signal. Electrical processing circuit 22 is shown as being connected with indicator 26 via a single line (not numbered), but could be coupled in a different manner such as a data bus, wireless connection, etc.

More specifically, electrical processing circuit 22 uses a value of the output signal from indicator 26 representing an amount of material within hopper 20 to adjust an amount of thrust or braking which is applied to a wheel 16 via a corresponding motor 18. Specifically, electrical processing circuit 22 actuates one or more motors 18 such that an amount of thrust or braking that is applied to a corresponding motor 18 is proportional to an amount of material within hopper 20. The amount of material can correspond to a mass of the material, weight of the material, or volume of the material. The degree to which one or more electric motors 18 are actuated can be based upon a calculation or look up table using the value of the corresponding output signal from indicator 26.

In another example, where the vehicle arrangement is autonomously or semi-autonomously operated, the timing of thrust or brake application may be adjusted in addition to or in place of the magnitude based on the load.

According to another aspect of the present invention, an optional pitch indicator 28 represents a pitch orientation of towed vehicle 10 relative to a horizontal reference. Pitch indicator 28 provides an output signal to electrical processing circuit 22, which is used in conjunction with the output signal representing the amount of material in hopper 20, to actuate one of motors 18. In one embodiment, electrical processing circuit 22 actuates one or more motor 18 to provide thrust or braking to a corresponding wheel 16 in an amount which is proportional to the pitch orientation of towed vehicle 10. The pitch indicator 28 may be in the form of a) an inclinometer; b) a tilt sensor; c) a 3-axis magnetic compass; d) a gyroscope; and/or e) an indication inferred from geo-referenced slope data. The geo-referenced slope data can be obtained from a previously GPS mapped soil survey of a given field, topographical map, etc.

According to yet another aspect of the present invention, electrical processing circuit 22 actuates one or more motors 18 to provide thrust or braking to a corresponding wheel 16, dependent upon surface data representing a physical attribute of a surface on which towed vehicle 10 is operating. For example, the surface data can be obtained from a user input or other source, and can represent a wet, dry or muddy soil condition. This surface data can be used in conjunction with the values of the indicator output signal and/or pitch indicator output signal to determine the amount of thrust or braking that is applied to a given motor 18.

It is also possible to limit the torque which is applied to a motor 18 such that damage does not occur to the chassis, drive train, etc. For example, electrical processing circuit 22 may be configured to apply a command signal effecting a maximum torque to a given motor 18 and wheel 16 which is less than a maximum threshold amount. Furthermore, it may be possible to simply limit the maximum output torque of a given motor 18 so that the maximum torque is below a threshold value.

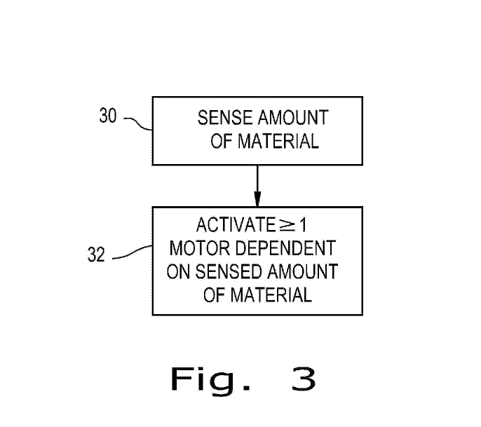

Referring now to FIG. 3, there is shown a simplified illustration of a method of towing a towed vehicle 10 of the present invention. At box 30, an amount of the material within hopper 20 is sensed (or alternatively inferred). Based on the value of an output signal from indicator 26, electrical processing circuit 22 actuates one or more electric motors 18 to apply a thrust or braking action to a corresponding wheel 16, as desired and appropriate (block 32).

The present invention has an advantage in that a large tow vehicle 12 is no longer needed to pull or tow a heavy towed vehicle 10. This allows the size of the tow vehicle 12 to be decreased, which in turn decreases the cost of the required vehicle as well as associated operating costs like fuel, etc. The towed vehicles 10 can even be coupled together in a train arrangement while still allowing the use of a relatively small tow vehicle 12.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A vehicle arrangement, comprising:
a tow vehicle;
a towed vehicle including at least two wheels and at least one motor, each said motor being coupled with a corresponding said wheel;
an indicator associated with an amount of material carried onboard said towed vehicle, said indicator providing an output signal representing said amount of material; and
an electrical processing circuit coupled with said indicator, said electrical processing circuit actuating at least one said motor, dependent upon said output signal.

2. The vehicle arrangement of claim 1, wherein said electrical processing actuates said at least one motor to provide one of thrust and braking to a corresponding said wheel, proportional to said amount of material represented by said output signal.

3. The vehicle arrangement of claim 1, wherein said amount of material corresponds to one of: a) a weight of the material; b) a mass of the material, and c) a volume of the material.

4. The vehicle arrangement of claim 1, wherein said indicator includes one of:
a) an onboard scale;
b) an onboard optical sensor;
c) an onboard ultrasonic sensor;
c) at least one contact switch; and
d) a remote indicator.

5. The vehicle arrangement of claim 4, wherein said remote indicator includes at least one of:
a) an external scale;
b) a mass flow sensor; and
c) a grain yield monitor.

6. The vehicle arrangement of claim 1, wherein said indicator includes a sensor arrangement for sensing an amount of material carried onboard said towed vehicle at any given point in time during operation of said towed vehicle.

7. The vehicle arrangement of claim 1, wherein said indicator is based on one of a) sensing an amount of material carried by said towed vehicle, and b) inferring an amount of material carried by said towed vehicle.

8. The vehicle arrangement of claim 2, further including a pitch indicator representing a pitch orientation of said towed vehicle.

9. The vehicle arrangement of claim 8, wherein said pitch indicator includes at least one of:
a) an inclinometer;
b) a tilt sensor;
c) a 3-axis magnetic compass;
d) a gyroscope; and
e) an indication inferred from geo-referenced slope data.

10. The vehicle arrangement of claim 8, wherein said electrical processing circuit actuates said at least one motor to provide one of thrust and braking to a corresponding said wheel, proportional to said pitch orientation of said towed vehicle.

11. The vehicle arrangement of claim 10, wherein said electrical processing circuit actuates said at least one motor to provide one of thrust and braking to a corresponding said wheel, dependent upon surface data representing a physical attribute of a surface on which said towed vehicle is operating.

12. The vehicle arrangement of claim 10, wherein one of said electrical processing circuit and said at least one motor includes a torque limiter for limiting an amount of said thrust or braking that is applied to said at least one motor.

13. The vehicle arrangement of claim 1, wherein said motor is an electric motor.

14. The vehicle arrangement of claim 13, including an electrical power source for providing electrical power to said at least one motor.

15. The vehicle arrangement of claim 14, wherein said electrical power source includes one of a) at least one battery, b) at least one fuel cell, and c) an internal combustion engine.

16. The vehicle arrangement of claim 1, wherein said towed vehicle is a towed implement.

17. A towed vehicle arrangement, comprising:
a frame;
at least two wheels carried by said frame;
at least one motor, each said motor being coupled with a corresponding said wheel;
an indicator associated with an amount of material carried onboard said towed vehicle, said indicator providing an output signal representing said amount of material; and
an electrical processing circuit coupled with said indicator, said electrical processing circuit actuating at least one said motor, dependent upon said output signal.

18. The towed vehicle arrangement of claim 17, wherein said electrical processing actuates said at least one motor to provide one of thrust and braking to a corresponding said wheel, proportional to said amount of material represented by said output signal.

19. The towed vehicle arrangement of claim 17, wherein said indicator is based on one of a) sensing an amount of material carried by said towed vehicle, and b) inferring an amount of material carried by said towed vehicle.

20. The towed vehicle arrangement of claim 18, further including a pitch indicator representing a pitch orientation of said towed vehicle.

21. The towed vehicle arrangement of claim 20, wherein said electrical processing circuit actuates said at least one motor to provide one of thrust and braking to a corresponding said wheel, proportional to said pitch orientation of said towed vehicle.

22. The towed vehicle arrangement of claim 21, wherein said electrical processing circuit actuates said at least one motor to provide one of thrust and braking to a corresponding said wheel, dependent upon surface data representing a physical attribute of a surface on which said towed vehicle is operating.

23. A method of towing a towed vehicle using a tow vehicle, the towed vehicle having at least one motor with each motor being coupled with a corresponding wheel, said method comprising the steps of:
determining an amount of material carried onboard said towed vehicle; and
actuating at least one said motor using an electrical processing circuit, dependent upon said determined amount of material.

24. The method of claim 23, wherein said determining step is carried out using an indicator providing an output signal representing said amount of material; and wherein said electrical processing circuit actuates said at least one said motor, dependent upon said output signal.

25. The method of claim 24, wherein said electrical processing actuates said at least one motor to provide one of thrust and braking to a corresponding said wheel, proportional to said amount of material represented by said output signal.

26. The method of claim 24, wherein said indicator includes a sensor arrangement for sensing an amount of material carried onboard said towed vehicle at any given point in time during operation of said towed vehicle.

27. The method of claim 24, wherein said indicator is based on one of a) sensing an amount of material carried by said towed vehicle, and b) inferring an amount of material carried by said towed vehicle.

28. The method of claim 27, further including a pitch indicator representing a pitch orientation of said towed vehicle.

29. The method of claim 28, wherein said electrical processing circuit actuates said at least one motor to provide one of thrust and braking to a corresponding said wheel, proportional to said pitch orientation of said towed vehicle.

30. The method of claim 29, wherein said electrical processing actuates said at least one motor to provide one of thrust and braking to a corresponding said wheel, dependent upon surface data representing a physical attribute of a surface on which said towed vehicle is operating.
